(19) United States
(12) Patent Application Publication
(10) Pub. No.: US 2025/0278635 A1
(43) Pub. Date: Sep. 4, 2025

(54) DECISION RECOMMENDATION SYSTEM FOR BESS PROJECTS BASED ON DYNAMIC RISK ASSESSMENT

(71) Applicant: HITACHI, Ltd., Tokyo (JP)

(72) Inventors: Amit KUMAR, San Jose, CA (US); Nam HUYN, Milpitas, CA (US); Arnab CHAKRABARTI, Milpitas, CA (US); Ravigopal VENNELAKANTI, San Jose, CA (US)

(21) Appl. No.: 18/591,952

(22) Filed: Feb. 29, 2024

(51) Int. Cl. G06N 3/092

(52) U.S. Cl. CPC G06N 3/092

(57) ABSTRACT

Systems and methods described herein are directed to a method for a reinforcement learning based battery energy storage system (BESS) project approval decision model, including gathering data related to the BESS across a plurality of sources, wherein one of the plurality of sources comprises a blockchain system configured to provide a BESS performance data for existing installations across stakeholders of the existing installations; computing prior benefit realization probabilities and risk exposure probabilities from the gathered data for the BESS; training the reinforcement learning model from the computed prior benefit realization probabilities and the risk exposure probabilities; and executing the reinforcement learning model to generate a decision for a target BESS project approval in response to an input associated with input target BESS.

### BACKGROUND

### Field

The present disclosure is generally directed to battery systems, and more specifically, to decision recommendation systems for Battery Energy Storage Systems (BESS) based on dynamic risk assessment.

### Related Art

An energy storage system is more than just a battery, and requires additional components such as the balance of the system, energy management system, and power conversion system that allow the battery to be connected to an electrical network. BESS project planning is a tedious job since various factors must be considered, including revenue potential, system cost, reliability, suitable type of storage, power and voltage quality, frequency deviations, and environmental issues.

Due to high capital expenditures, uncertainty in reliability and long-term performance of Li-ion based BESS, supplier insolvency risks during typically long project lifetime, and supply chain disruption risks, BESS system owners are looking for ways to share risks among BESS integrators, battery module manufacturers, financing companies, and insurance providers. However, traditional banks and insurance providers are unable to assess risk due to lack of reliability data, usage data, and claims data in different environments. Long-term battery testing data shows that battery performance degradation is not linear, and it is hard to predict when a particular system will fail. Although battery manufacturers typically provide ten years of warranty, many battery manufacturers are new, or many battery technologies are unproven in the market, leading to high supplier insolvency risks in this industry. Moreover, there is a lack of reliable information on battery performance and claims data due to data silos and absence of trusted sharing mechanisms.

In the related art, there are implementations for the optimal investment timing and sizing for battery energy storage systems. Such related art implementations involve a methodology for applying real options analysis to a BESS project from the perspective of private investors to determine the optimal investment time and BESS capacity size (MWh). Two different optimization models are designed, 1) called the operational model for determining BESS dispatch strategy and expected daily revenue from BESS, and 2) the planning model which optimizes investment timing and sizing decisions. The operational model is solved using a reinforcement learning algorithm called Deterministic Policy Gradient (DPG). The planning model is solved using a direct-search based approach with a nonlinear optimizer.

In the related art, there are battery energy storage systems and control systems and applications. In such related art implementations, a battery pack having an operating system is used to collect battery data and to produce battery rate data that is used to sell battery insurance. Additionally, the battery data (stored for example in a data center) is analyzed and used to form rate data for insurance purposes. For example, the battery data can be analyzed to determine an expected lifetime for particular batteries made by particular battery manufacturers and/or particular battery packs made by particular manufacturers. This expected lifetime data can then be used to determine the cost of insurance sold to cover battery packs. Batteries and battery packs that have a longer expected lifetime can potentially get term insurance coverage at a lower rate than batteries and battery packs that have a shorter expected lifetime. The rate data is determined similarly to how life insurance rate data is determined.

In the related art, there is a battery pack monitoring and warranty tracking system. Systems and methods are disclosed for monitoring battery usage information. Battery usage data is received from a battery energy storage system comprising a battery pack. The battery usage data may include battery identification information, one or more battery sensor measurements for a period of time, and a cumulative warranty value for the battery pack.

### SUMMARY

The battery energy storage market is not monolithic. There is a wide range of revenue and risk profiles based on site location, project type, system owner's and suppliers' financial performance, and tax credit eligibility. For example, California markets are different from Texas, where storage projects are being built to provide short-duration products into the market, often with selective hedges. Moreover, long-term offtake agreements with utility grid has revenue certainty advantage, whereas uncontracted merchant sales have less revenue certainty compared to that traditionally required by lenders and tax equity investors.

Banks want to understand, and get reasonably comfortable, that a project will have a durable revenue flow over the term of the loan. They often require system owners to maintain a certain Debt Service Coverage ratio (DSCR) in their financial performance. Lithium-ion batteries have uncertainty in reliability and long-term performance. Long-term battery testing data shows degradation is not linear, and it is hard to predict when a particular system will fail.

Standard warranties for lithium-ion batteries covering both performance and defects are two years, but extended warranties will need to be purchased. For product defect warranties, the warranty provider promises to repair the product if there is a defect. For performance warranty, the warranty covers four key attributes of a system over time—capacity, energy or power, availability and round-trip efficiency, or some combination of all of those.

Many battery manufacturers are new or many battery technologies are not completely proven in the market, so supplier insolvency risks are high in this industry. For OEMs or technologies with a limited track record, third-party re-insurers can backstop warranties that cover performance and even business continuity risk.

BESS installations require high capital expenditures. Moreover, due to uncertainty in batteries' reliability and long-term performance, customers are looking for ways to share risks with OEM and financing/insurance providers. However, traditional banks are unable to assess risk and finance/insure due to a lack of reliability, usage, and claims data in different environments.

BESS failures require specialists to fix and may have a longer lead time for the provisioning of batteries and other components. Project developers typically rely on overprovisioning of the BESS system to compensate for inefficiencies, which increases system costs.

Battery degradation can be caused by a number of factors, such as but not limited to elevated temperatures, extremely high and low states of charge, fast charging or discharging, high-moisture environment, mechanical damage, or interactions with other components.

Battery warranties comes with many conditions. For example, a leading battery manufacturer requires the operator to maintain the battery at a certain temperature and state of charge or that voids the warranty. The conditions put the onus on the operator to track the data to protect the customer and to enable it to go back to the battery manufacturer with proof that the system was controlled in accordance with the warranty conditions.

Example of battery health and usage data include maximum current running through the system for a period and the minimum and maximum state of charge of the battery. It will usually want to see data logged at 15-minute intervals.

Risk and benefit assessment for BESS projects can be tricky due to uncertainty over operating conditions (e.g., temperature, cycle rate, and charging profiles), uncertainty in reliability and long-term performance of batteries, lack of predictable claim models, absence of “law of large numbers”, or increased catastrophe loss activity. Assumptions of BESS operations differ significantly from what actually happens. This leads to faulty modeling and suboptimal decision-making.

Information silos and distrust in the ecosystem can cause delays and losses in warranty and insurance claims reconciliations.

When insurance providers underwrite storage projects, they have an independent engineer evaluate contracts, project scope, hardware, and software. Underwriters often do not have adequate data available to assess the risk.

Insurance and financing decisions for new BESS installations can be tricky due to a lack of historical data related to battery reliability, performance, and expected usage scenarios. There is a need to determine how much will it cost to warrant the overall system performance over the project's lifetime. Due to lack of historical data, insurers can use a dynamic insurance pricing model to evaluate risks each year and determine premium for the next twelve months. There is a need to determine how much will it cost to warrant against flexible cycling profiles.

Insurance renewal and warranty extension decisions for existing BESS installations can be tricky due to uncertainty over operating conditions (e.g., temperature, cycle rate, and charging profiles, uncertainty in reliability and long-term performance of batteries, lack of predictable claim models, absence of “law of large numbers”, and increased catastrophe loss activity). Moreover, it takes time and money to file, validate, and adjust a warranty claim.

Aspects of the present disclosure can involve a method for a reinforcement learning based battery energy storage system (BESS) project approval decision model, including gathering data related to the BESS across a plurality of sources, wherein one of the plurality of sources comprises a blockchain system configured to provide a BESS performance data for existing installations across stakeholders of the existing installations; computing prior benefit realization probabilities and risk exposure probabilities from the gathered data for the BESS: training the reinforcement learning model from the computed prior benefit realization probabilities and the risk exposure probabilities; and executing the reinforcement learning model to generate a decision for a target BESS project approval in response to an input associated with input target BESS.

Aspects of the present disclosure can involve a computer program for a reinforcement learning based battery energy storage system (BESS) project approval decision model, including instructions involving gathering data related to the BESS across a plurality of sources, wherein one of the plurality of sources comprises a blockchain system configured to provide a BESS performance data for existing installations across stakeholders of the existing installations; computing prior benefit realization probabilities and risk exposure probabilities from the gathered data for the BESS: training the reinforcement learning model from the computed prior benefit realization probabilities and the risk exposure probabilities; and executing the reinforcement learning model to generate a decision for a target BESS project approval in response to an input associated with input target BESS. The computer program and instructions can be stored on a non-transitory computer readable medium and executed by one or more processors.

Aspects of the present disclosure can involve a system for a reinforcement learning based battery energy storage system (BESS) project approval decision model, including means for gathering data related to the BESS across a plurality of sources, wherein one of the plurality of sources comprises a blockchain system configured to provide a BESS performance data for existing installations across stakeholders of the existing installations; means for computing prior benefit realization probabilities and risk exposure probabilities from the gathered data for the BESS; means for training the reinforcement learning model from the computed prior benefit realization probabilities and the risk exposure probabilities; and means for executing the reinforcement learning model to generate a decision for a target BESS project approval in response to an input associated with input target BESS.

Aspects of the present disclosure can involve an apparatus, configured to facilitate a reinforcement learning based battery energy storage system (BESS) project approval decision model, the apparatus including a processor, configured to gather data related to the BESS across a plurality of sources, wherein one of the plurality of sources comprises a blockchain system configured to provide a BESS performance data for existing installations across stakeholders of the existing installations; compute prior benefit realization probabilities and risk exposure probabilities from the gathered data for the BESS; train the reinforcement learning model from the computed prior benefit realization probabilities and the risk exposure probabilities; and execute the reinforcement learning model to generate a decision for a target BESS project approval in response to an input associated with input target BESS.

### BRIEF DESCRIPTION OF DRAWINGS

FIG. 1 illustrates an example BESS project approval recommendation system, in accordance with an example implementation.

FIG. 2A illustrates a representative list of major BESS risk categories, in accordance with an example implementation.

FIG. 2B illustrates an example of the calculation of benefit realization probabilities (priors) in accordance with an example implementation.

FIG. 3 illustrates examples of the system flow, in accordance with an example implementation.

FIG. 4 illustrates an example output of the optimal approval decision for target BESS project based on project profile segments, in accordance with an example implementation.

FIG. 5 illustrates an example of the solution framework for assessing risks and future benefits from BESS operations and recommending optimal approval decisions for target BESS projects, in accordance with an example implementation.

FIG. 6 illustrates an example flow diagram to generate simulators to simulate operating conditions and risk environment in accordance with an example implementation.

FIG. 7 illustrates an example flow for synthesizing data used to train and test recommendation system, in accordance with an example implementation.

FIG. 8 illustrates a plurality of systems that are networked to a management apparatus, in accordance with an example implementation.

FIG. 9 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

Example implementations described herein involve a system for recommending an optimal approval decision for the target BESS project as well as dynamically balancing expected risk impacts with expected benefits from target BESS projects. In example implementations, there is also a blockchain-based system to establish a single truth in sharing BESS performance and claims data amongst all stakeholders including system owner, BESS integrator, battery manufacturer, service provider, insurance provider, and lender. A blockchain database is a decentralized digital ledger of transactions maintained by a network of computers for secure and transparent record-keeping.

Example implementations described herein can involve an insurance pricing and claims management system that will recommend optimal premium pricing for BESS units and enable single truth in battery performance and claims data. In example implementations, a reinforcement learning model is trained to gradually learn the best actions (pricing decision) that will optimize revenue while balancing the risk exposure. To enable trust in battery performance and claims data, a permissioned blockchain solution connecting seven stakeholder types in the BESS insurance ecosystem is also provided.

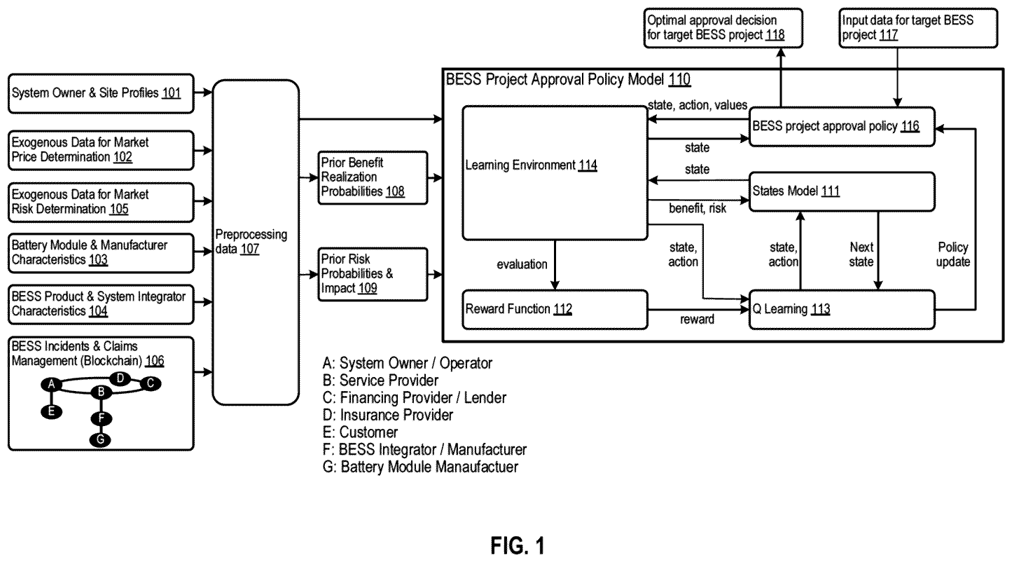

FIG. 1 illustrates an example BESS project approval recommendation system, in accordance with an example implementation. Examples of categories of data as input for the policy model are indicated as follows.

System Owner & Site Profiles 101 is input from which the system creates groups of system owners based on key data attributes such as size, location, and credit ratings, and can also function as a survey for price acceptability. For example, one possible data attribute can be site location. An optimal site location would have advantages of energy arbitrage, loss and emission reductions, and peaking photovoltaic generation. Moreover, location can be important from an environmental risk perspective (e.g., natural hazards). Another example data attribute can involve power size. Power size can be important both from revenue potential and risk exposure perspectives. Bigger installations have higher revenue potential as well as higher risk of loss. Another example data attribute can be the number of peak days, as long periods of high charge and discharge rates can cause faster battery degradation.

Exogenous data for market price determination 102 is input from which the system uses the market data for competitor pricing for price acceptance probabilities determination. Example data attributes can involve the electricity price, as high electricity price and intra-day price fluctuation makes a good case for BESS investments. Another example data attribute can involve battery cell price forecast which will help estimate future cost of new BESS and replacement modules. Another example data attribute can involve tax credits, as federal and state level tax credits can have positive impact on BESS investments.

Battery module and Manufacturer Characteristics 103 is input from which the system creates groups of battery modules technology based on key data attributes such as battery chemistry, technology readiness level, and manufacturing readiness level. For example, battery chemistry can be a data attribute as lithium-ion batteries are not all the same. LFP batteries are also safer and more abuse tolerant than oxide-based lithium-ion batteries. Another example attribute can involve battery module warranty terms, as the terms can have impact on total life-time costs of BESS installations. Another example attribute can involve a manufacturer credit rating as a battery manufacturer credit rating can be used as a proxy for supplier insolvency risk.

BESS product & System Integrator Characteristics 104 is input from which the model creates groups of BESS products based on key data attributes such as BESS unit size, unit warranty, and system integrator credit rating. For example, a data attribute such as BESS unit sensing can involve data from sensors installed in the BESS unit that can provide early warning of technical issues, thereby preventing losses. Another example data attribute can involve BESS unit warranty, as warranty terms can have impact on total life-time costs of BESS installations. Another example data attribute can involve BESS integrator credit rating, which can be used as a proxy for supplier insolvency risk.

Exogenous data for market risks determination 105 is input from which the system uses key market indicators such as inflation, battery price forecasts, and extreme weather event forecasts for risk probabilities determination. For example, weather forecasts can indicate extreme environmental conditions (e.g., extremely high or cold temperature, flood), which can cause significant losses. Another example data attribute can involve inflation, which can have impact on BESS price and service costs. Another example data attribute can involve supply disruptions, as battery and other component supply chain disruptions can lead to delays in replacement or new installations. Organizations in the blockchain can include, but is not limited to, system owner/operator, service provider, financing provider/lender, insurance provider, customer, BESS integrator/manufacturer, battery module manufacturer, and so on.

BESS incidents and claims management 106 is input as a blockchain database in which the system uses BESS incidents and claims history data from existing installations where available. Examples of data attributes can involve battery health anomalies, which can provide early warning of issues and help prevent losses. Another example data attribute can involve BESS claims as trusted data on past claims can help underwriters assess the risk better. Another example data attribute can involve service response and repair time, which can help in estimating future losses.

Such input is preprocessed to form preprocessing data 107 which can be used to derive additional data as follows. Prior benefit realization probabilities 108 can be derived based on system owner survey data. Risk probabilities and impact 109 is also derived based on battery module and BESS characteristics, past performance and claims data, and exogenous data for market risks.

BESS Project Approval Policy Model 110 can involve reinforcement learning with techniques as follows.

States Model 111 can involve vectors such as owner decision, time of decision, lender response, net expected profit, site features, market features, supplier features, and so on.

Reward function 112 can provide an expected benefit realization based on proposal acceptance probabilities minus expected loss based on risk probabilities.

Q learning 113 is a temporal difference learning algorithm that gradually builds information about the best actions to take in each possible state. This is achieved by finding a policy that maximizes benefits while balancing risks. Q learning 113 provides policy updates to the trained machine learning model for BESS project approval policy 116.

Learning environment 114 is a reinforcement learning environment that intakes the states from the states model 111 as well as the action recommended by the trained machine learning model for the BESS project approval policy 116, simulation decisions from all other stakeholders, and provides output for evaluation by the reward function 112. Learning environment 114 implicitly learns actual benefits and risks.

BESS project approval policy 116 is the underlying trained machine learning model for the BESS project approval policy model 110 which intakes input data for the target BESS project 117 and provides an optimal approval decision for the target BESS project 118 after executing the learned project approval policy 116 and providing reinforcement learning to learning environment 114.

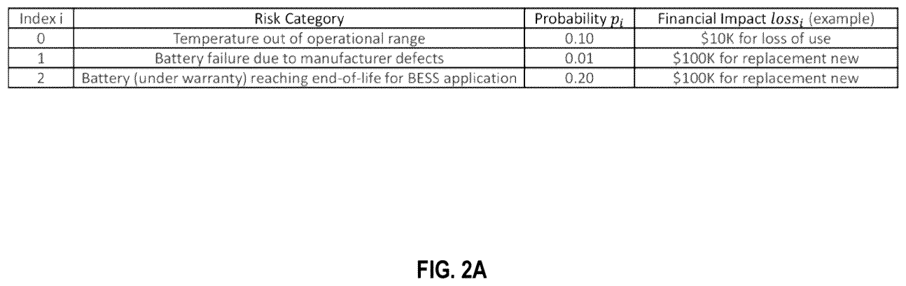

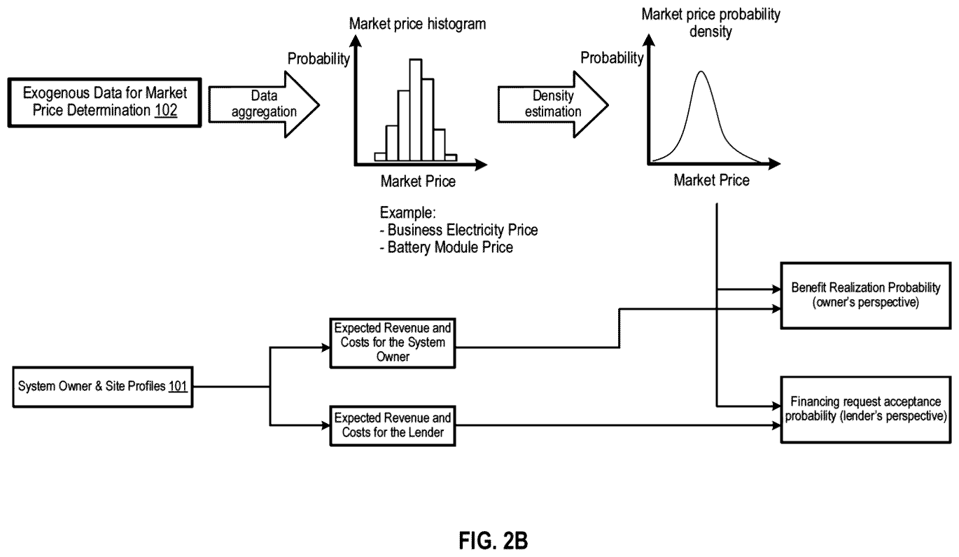

To determine risk exposures involved in BESS battery warranty, the first step is to make an inventory of all the battery-related adverse events or risk categories that could result in monetary loss to the BESS owner/operator and that would need insurance coverage. These risk categories can be elicited from the main stakeholders in a BESS warranty ecosystem, namely the insurers, System owners, BESS integrator, and battery OEMs. FIG. 2A illustrates a representative list of major BESS risk categories which, for the sake of simplicity, are assumed to be mutually independent and complete. Probability and financial impact are given for illustrative purposes only. Actual risk probability and impact will depend on various factors including battery chemistry, manufacturer readiness, operations, external environmental conditions.

In the example of FIG. 2A, the risk categories represent binary events, that is, adverse events that may or may not occur within a given warranty coverage period (e.g., a 12-month period). These categories represent all possible risks that have a non-negligible probability of occurrence. The probability of a given adverse event can be estimated using different methods. For example, if historical data is available, it can be estimated using statistical models built from the data. In practice however, failure events are rare and hard to come by, especially when dealing with new battery products that have little historical data. In that case, manufacturer specifications may have to be used, despite their potential for bias.

Further, the probability of an adverse event may not be static. It can also be influenced by information obtained through continued monitoring of a battery's internal state such as internal temperature, estimated life cycle count, voltage and internal resistance. Also, when close to reaching end-of-life, a battery performance degradation may accelerate.

Financial impact of a given loss can be quantified easily most of the time. For the system owner, it represents the revenue loss caused by the loss of use of the battery for the duration of time needed to bring the battery back to full operation. In cases where a battery must be replaced, then we need to add the purchase price of a new battery which may fluctuate over time and which may incur additional delays due to potential supply chain issues.

FIG. 2B illustrates an example of the calculation of benefit realization probabilities (priors) in accordance with an example implementation. Based on system owner and site profile data, expected revenue and costs can be calculated from both system owner's and lender's perspectives. Using exogeneous data from market's historical trends and future forecasts, market price probability density for future periods can be established for each revenue and cost parameter such as business electricity price, battery cell price, and interest rate. From system owner's perspective, benefit realization probability can be determined by applying market price probability density of each revenue and cost parameter to the expected revenue and costs for the system owner. Similarly, financing request acceptance probability can be estimated by applying market price probability density of each revenue and cost parameter to the expected revenue and costs for the lender. To determine risk exposures involved in a BESS battery warranty, the first step is to obtain the exogenous data for market prices determination 102. That is, the example implementations make an inventory of all the battery-related adverse events or risk categories that could result in monetary loss to the BESS owner/operator and that would need insurance coverage. These risk categories can be elicited from the main stakeholders in a BESS warranty ecosystem, namely the insurers, system owners, battery OEM, and BESS integrator. Risk exposure can be defined as expected loss. With the assumption that the adverse events are mutually independent, all the information to compute exposure is provided for computation with the equation below, where pi is individual risk probability, lossi is expected loss, and n is number of risks identified.

$$Exposure = {\sum }_{i = 1}^{n} {p}_{i} \times {loss}_{i}$$

Without the independence assumption, all the joint probabilities need to be estimated, which may be challenging to obtain accurately in practice. While the concept of exposure is easy to grasp, it may not be informative enough to help the insurance company determine the premium to provide the coverage. To provide more information, consider the risk probability distribution, which can be written as:

$$Risk Probability Distribution = {\sum }_{Subset S of indices} ( {\prod }_{i ∈ S} {p}_{i} ) \times ( {\prod }_{j ∉ S} 1 - {p}_{j} ) \times {1}_{{\sum }_{k ∈ S} {loss}_{k}}$$

In an example of the reinforcement learning of the BESS Project approval policy model 110, suppose that the possible proposals from the owner can be financing without performance insurance, financing with performance insurance, decision deferred, or so on. The Lender's response can involve no response, negotiate, or accept proposal. In such an example, the reward function 112 can be the total net expected profit (Expected profit minus expected losses based on risk probabilities) over project lifetime as represented as an equation as follows:

$$Reward = ( {\sum }_{j = 1}^{m} ( {ExpectedProfit}_{j} ) - {\sum }_{j = 1}^{m} {\sum }_{i = 1}^{n} ( {RiskProbability}_{j , i} \times {RiskImpact}_{j , i} ) )$$

Where ExpectedProfitⱼ is expected profit from the BESS project in the year j (expected revenue minus expected costs)
RiskImpactᵢ be the expected impact of a specific risk type (value in decimal)
RiskProbability_{j,i} be the probability for a specific risk type (value in decimal) in the year j
m is the project lifetime in years
n is the number of risks identified for the specific project

In another example, each state can be represented as a vector of the following features: Derived features from installation profiles, the total number of negotiations from the beginning of the trajectory, and time steps at which offers of each type were issued. Reward function is the total expected profit (expected revenue minus expected losses based on identified risks).

$$Reward = Cov \times ( ( PremRate \times {\sum }_{j = 1}^{m} ( 1 - {D}_{j} ) ) - {\sum }_{j = 1}^{m} {\sum }_{i = 1}^{n} ( RiskProbj , i \times ImpactRate j , i ) )$$

Where Cov is the maximum coverage amount per unit of insurance; PremRate is the policy premium rate (value in decimal); Dⱼ is a discount % based on risk assessment (value in decimal);

ImpactRate_{j,i} is the impact rate of the maximum coverage amount for a specific risk type (value in decimal); RiskProbability_{j,i} is the risk probability for a specific risk type (value in decimal); m is the total insurance units purchased by customers; n is the number of risks identified for the specific installation.

Example implementations utilize Q learning 113 that gradually builds information about the best actions to take in each possible state. The action-value Q(s, a) is estimated using Fitted Q Iteration (FQI) algorithm as it can use any supervised learning algorithm to approximate the Q function. To approximate Q function, Random Forest Regression can be utilized. Moreover, an epsilon-greedy policy that randomly explores non-optimal actions with some small probability defined by the hyperparameter epsilon (ϵ) can be utilized. Q learning 113 is a temporal difference learning algorithm that gradually builds information about the best actions to take in each possible state. This is achieved by finding a policy that maximizes profit while balancing risk exposure.

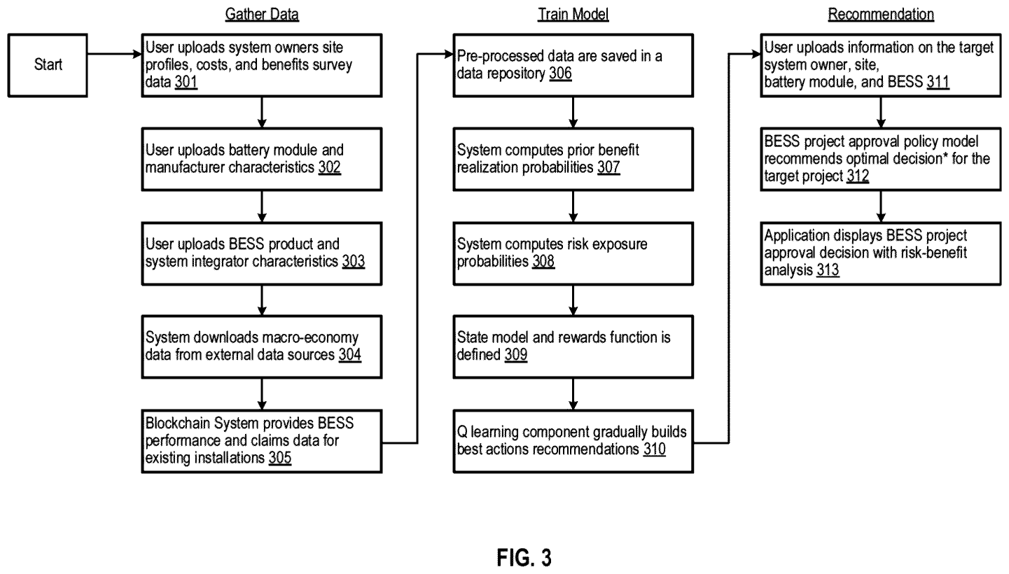

FIG. 3 illustrates examples of the recommendation system flow diagram, in accordance with an example implementation. From 301 to 305, the system gathers data. At 301, the user uploads system owners, site profiles, costs and benefits survey data as system owner & site profiles 101. At 302, the user uploads battery module and manufacturer characteristics in battery module and manufacturer characteristics 103. At 303, the user uploads BESS product and system integrator characteristics in BESS product & system integrator characteristics 104. At 304, the system downloads macro-economy data from external data sources to obtain the exogenous data for market risk determination 105 as well as the exogenous data for market price determination 102. At 305, the blockchain system provides BESS performance and claims data for existing installations from BESS incidents & claims management 106.

From 306 to 310 the system trains the reinforcement learning recommendation policy. At 306, pre-processed data are saved in a data repository after undergoing preprocessing data 107. At 307, the system computes prior benefit realization probabilities 108. At 308, the system computes prior risk exposure probabilities and impact 109. At 309, the states model 111 and rewards function 112 are defined. At 310, the Q learning 113 component gradually builds the best actions recommendations.

From 311 to 313, the system can provide recommendations based on the trained policy. At 311, the user uploads information on the target system owner, site, battery module, and BESS as the input data for the target BESS project 117. At 312 the BESS project approval policy model recommends optimal decision* for the target project via the trained model provided for BESS project approval policy 116. At 313, the model displays BESS project approval decision with risk-benefit analysis as optimal approval decision for target BESS project 118.

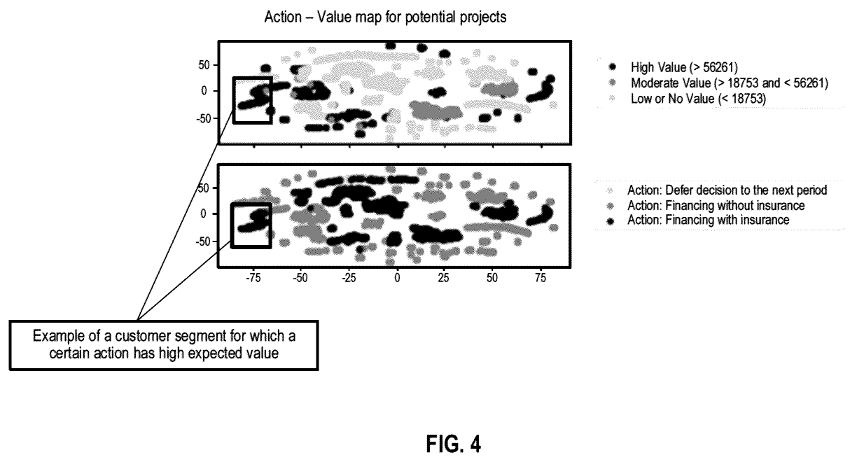

FIG. 4 illustrates an example output of the optimal approval decision for target BESS project, in accordance with an example implementation. Examples of decision options can involve rejecting or deferring decisions to the next period, approving and applying financing without buying performance insurance, approving and applying for financing with purchase of performance insurance and so on in accordance with the desired implementation. As illustrated in FIG. 4, customer segments for which a certain action has a high expected value can be provided. Thus, a risk-based decision support system that enables approval decisions of BESS project by system owners, financing decisions by lenders, and performance guarantee of BESS units by insurance providers and OEMs can therefore be provided. Example implementations can facilitate a trusted platform for sharing BESS performance data and claims data. As illustrated in FIG. 4, the example implementations identify customer segments that can be targeted to achieve moderate to high value while minimizing risks and what offers should be made.

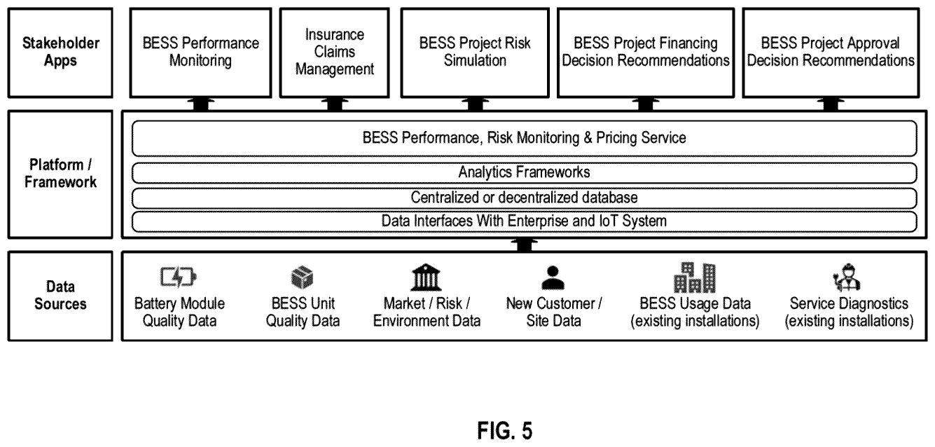

FIG. 5 illustrates an example of the solution framework for assessing risks and future benefits from BESS operations and recommending optimal approval decisions for target BESS projects, in accordance with an example implementation. As shown in FIG. 5, the data sources can include, but is not limited to, battery module quality data, BESS unit quality data, market/risk/environment data, new customer/site data, BESS Usage data (existing installations), service diagnostics (existing installations), and so on. The platform/framework can involve data interfaces with enterprise and Internet of Things (IoT) systems, centralized/decentralized databases, analytics frameworks, and BESS performance, risk monitoring and pricing services. Stakeholder applications can involve BESS performance monitoring, insurance claim management, BESS project risk simulation, BESS project financing decision recommendations, and BESS project approval decision recommendations.

Through the example implementations described herein the optimal price recommendations for providing insurance coverage related to performance guarantee of BESS unit for system owners, excessive warranty service costs for BESS System Integrators, battery module warranty costs for battery manufacturers, as well as trusted platform for sharing BESS performance data and claims data can be obtained.

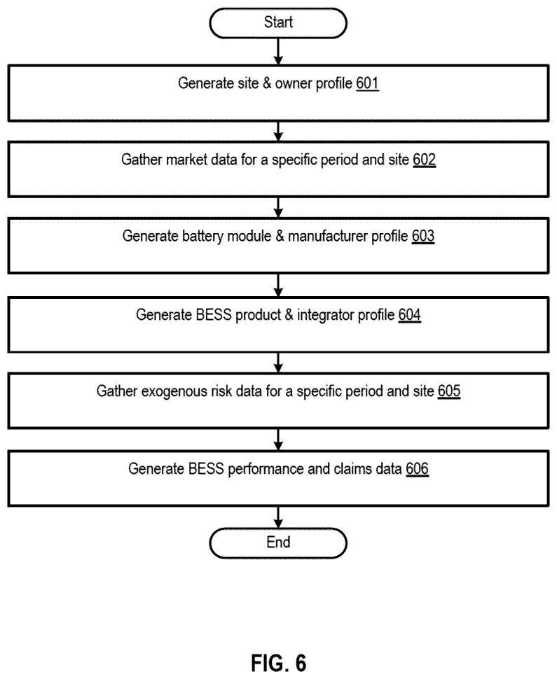

FIG. 6 illustrates an example flow diagram to generate simulators to simulate operating conditions and risk environment in accordance with an example implementation.

At 601 the site & owner profile is generated. Examples of data attributes can include size, location, peak days count, owner credit rating, expected benefits, or expected costs. At 602, the system gathers market data for a specific period and site. Such data can include electricity price, battery price, tax credit, and so on. At 603, the system generates the battery module & manufacturer profile, which can include attributes such as chemistry, module warranty, manufacturer credit rating, and so on.

At 604, the system generates the BESS product & integrator profile, which can include BESS unit sensing, unit warranty, integrator credit rating, and so on.

At 605, the system gathers exogenous risk data for a specific period and site, such as weather, inflation, and supply lead time.

At 606, the system generates BESS performance and claims data, which can include health anomalies, claims, and service response time.

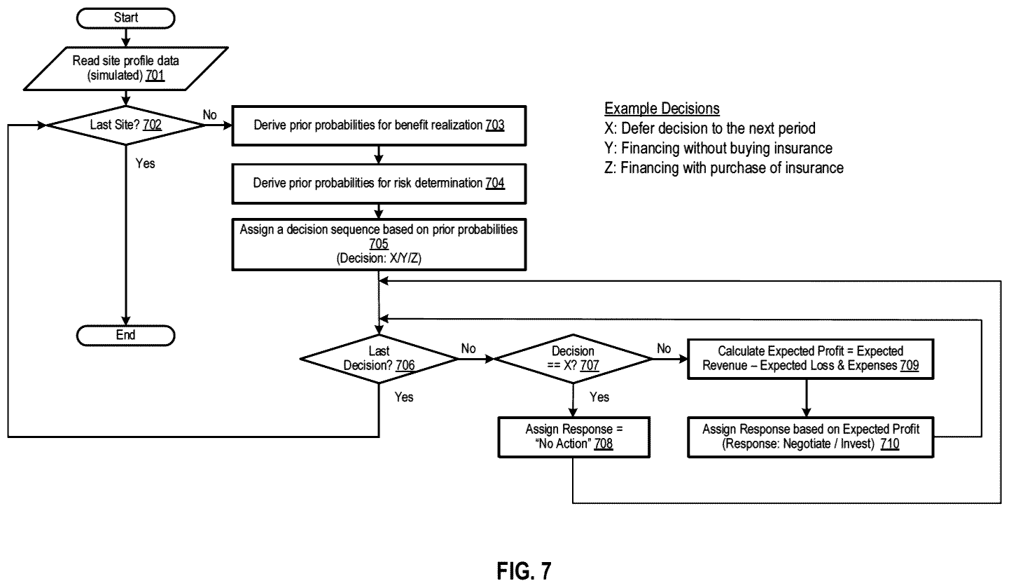

FIG. 7 illustrates an example flow for the training and test data creation of the system, in accordance with an example implementation. In particular, FIG. 7 illustrates synthesizing data used to train and test the recommendation system. At 701, the site profile data is read, which can be simulated. At 702, a determination is made as to whether the site profile data is read is the last site. If so (yes), the process ends, otherwise (No), the flow proceeds to 703 to derive prior probabilities to benefit realization. At 704, the flow then derives prior probabilities for risk determination. At 705, based on the derived probabilities, the system assigns a decision sequence based on prior probabilities. Such decisions can include, but are not limited to, defer decision to the next period, financing without buying insurance, financing with purchase of insurance, and so on.

At 706, a determination is made as to whether the assigned decision is the last one. If so (Yes), then the flow returns to 702, otherwise (No), the flow proceeds to 707 to determine if the decision is one that is to be deferred to the next period. If so (Yes), then the flow proceeds to 708 to assign a response of “No Action” and returns to 706, otherwise (No), the flow proceeds to 709 to calculate expected profit, and then assigns a response based on the expected profit at 710.

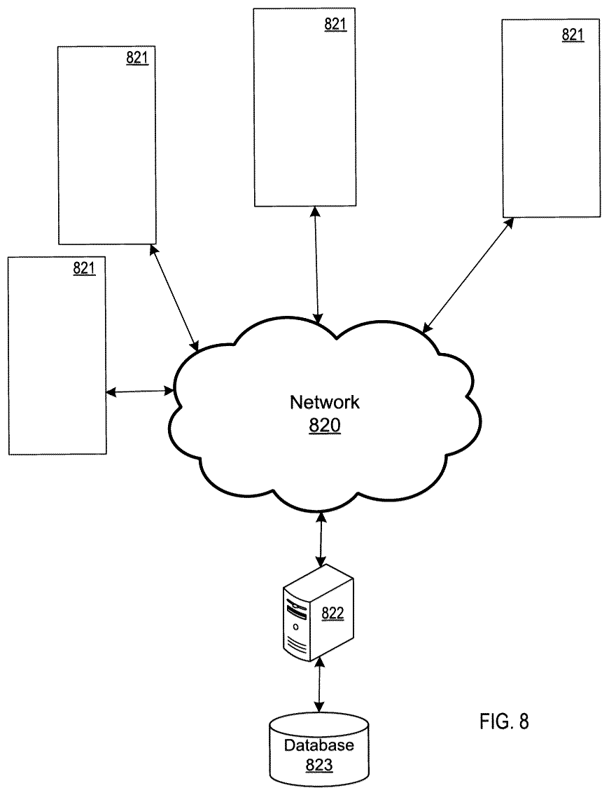

FIG. 8 illustrates a plurality of systems that are networked to a management apparatus, in accordance with an example implementation. One or more systems 821 (e.g., stakeholders, BESS systems, maintenance systems, sites, etc.) are communicatively coupled to a network 820 (e.g., local area network (LAN), wide area network (WAN)) through the corresponding network interface of the devices or servers associated with the systems 821, which is connected to a management apparatus 822. The one or more systems 821 may or may not be associated with sensors, depending on the desired implementation. The management apparatus 822 manages a database 823, which contains the data repository for preprocessed data as well as the trained reinforcement learning models as described herein. In alternate example implementations, the data can be stored in a central repository or central database such as proprietary databases that intake data from the physical systems 821, or systems such as enterprise resource planning systems, and the management apparatus 822 can access or retrieve the data from the central repository or central database.

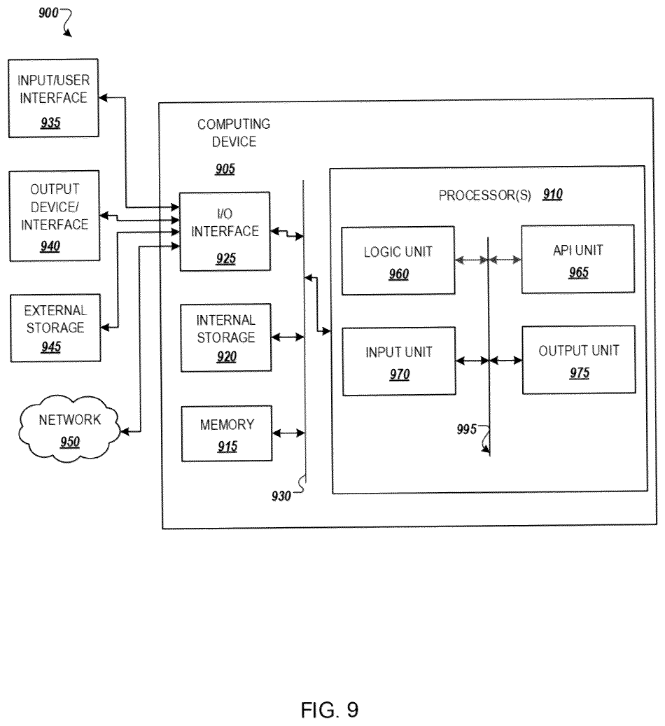

FIG. 9 illustrates an example computing environment with an example computer device suitable for use in some example implementations, such as the management apparatus 822 to facilitate the functionality of the systems described herein. Computer device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computer device 905. I/O interface 925 is also configured to receive images from cameras or provide images to projectors or displays, depending on the desired implementation.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

I/O interface 925 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

Processor(s) 910 can be configured to execute a method or instructions for a reinforcement learning based battery energy storage system (BESS) project approval decision model, including gathering data related to the BESS across a plurality of sources, wherein one of the plurality of sources comprises a blockchain system configured to provide a BESS performance data for existing installations across stakeholders of the existing installations; computing prior benefit realization probabilities and risk exposure probabilities from the gathered data for the BESS; training the reinforcement learning model from the computed prior benefit realization probabilities and the risk exposure probabilities; and executing the reinforcement learning model to generate a decision for a target BESS project approval in response to an input associated with input target BESS as illustrated for example, in FIG. 3. The project approval decision can include deferring a decision such as maintenance or buildout, controlling the BES to execute a shutdown to facilitate such maintenance or buildout, and so on, in accordance with the desired implementation.

Processor(s) 910 can be configured to execute the method or instructions as described above, wherein the decision for the target BESS involves risk-benefit analysis for the decision as shown in FIG. 4.

Processor(s) 910 can be configured to execute the method or instructions as described above, wherein the data related to the BESS includes battery module, battery manufacturing characteristics, BESS product and system integrator characteristics.

Processor(s) 910 can be configured to execute the method or instructions as described above, wherein the training the reinforcement learning model involves formulating a states model configured to learn benefit and risk for the BESS and return a state to a learning environment of the reinforcement learning model, wherein the reinforcement learning model undergoes policy updates from the learning environment as illustrated in FIG. 3.

Processor(s) 910 can be configured to execute the method or instructions as described above, wherein the decision indicates whether the target BESS project is to proceed or to be deferred as illustrated in FIG. 7.

Processor(s) 910 can be configured to execute the method or instructions as described above, wherein the training the reinforcement learning model involves assigning decision sequences based on the prior benefit realization probabilities and the risk exposure probabilities as illustrated in FIG. 7.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for a reinforcement learning based battery energy storage system (BESS) project approval decision model, comprising:
gathering data related to the BESS across a plurality of sources, wherein one of the plurality of sources comprises a blockchain system configured to provide a BESS performance data for existing installations across stakeholders of the existing installations;
computing prior benefit realization probabilities and risk exposure probabilities from the gathered data for the BESS;
training the reinforcement learning model from the computed prior benefit realization probabilities and the risk exposure probabilities; and
executing the reinforcement learning model to generate a decision for a target BESS project approval in response to an input associated with input target BESS.

2. The method of claim 1, wherein the decision for the target BESS comprises risk-benefit analysis for the decision.

3. The method of claim 1, wherein the data related to the BESS comprises battery module, battery manufacturing characteristics, BESS product and system integrator characteristics.

4. The method of claim 1, wherein the training the reinforcement learning model comprises formulating a states model configured to learn benefit and risk for the BESS and return a state to a learning environment of the reinforcement learning model, wherein the reinforcement learning model undergoes policy updates from the learning environment.

5. The method of claim 1, wherein the decision indicates whether the target BESS project is to proceed or to be deferred.

6. The method of claim 1. wherein the training the reinforcement learning model comprises assigning decision sequences based on the prior benefit realization probabilities and the risk exposure probabilities.

7. A non-transitory computer readable medium, storing instructions for a reinforcement learning based battery energy storage system (BESS) project approval decision model, the instructions comprising:
gathering data related to the BESS across a plurality of sources, wherein one of the plurality of sources comprises a blockchain system configured to provide a BESS performance data for existing installations across stakeholders of the existing installations:
computing prior benefit realization probabilities and risk exposure probabilities from the gathered data for the BESS;
training the reinforcement learning model from the computed prior benefit realization probabilities and the risk exposure probabilities; and
executing the reinforcement learning model to generate a decision for a target BESS project approval in response to an input associated with input target BESS.

8. The non-transitory computer readable medium of claim 7, wherein the decision for the target BESS comprises risk-benefit analysis for the decision.

9. The non-transitory computer readable medium of claim 7, wherein the data related to the BESS comprises battery module, battery manufacturing characteristics, BESS product and system integrator characteristics.

10. The non-transitory computer readable medium of claim 7, wherein the training the reinforcement learning model comprises formulating a states model configured to learn benefit and risk for the BESS and return a state to a learning environment of the reinforcement learning model, wherein the reinforcement learning model undergoes policy updates from the learning environment.

11. The non-transitory computer readable medium of claim 7, wherein the decision indicates whether the target BESS project is to proceed or to be deferred.

12. The non-transitory computer readable medium of claim 7, wherein the training the reinforcement learning model comprises assigning decision sequences based on the prior benefit realization probabilities and the risk exposure probabilities.

13. An apparatus, configured to facilitate a reinforcement learning based battery energy storage system (BESS) project approval decision model, the apparatus comprising:
a processor, configured to:
gather data related to the BESS across a plurality of sources, wherein one of the plurality of sources comprises a blockchain system configured to provide a BESS performance data for existing installations across stakeholders of the existing installations;
compute prior benefit realization probabilities and risk exposure probabilities from the gathered data for the BESS;
train the reinforcement learning model from the computed prior benefit realization probabilities and the risk exposure probabilities; and
execute the reinforcement learning model to generate a decision for a target BESS project approval in response to an input associated with input target BESS.

14. The apparatus of claim 13, wherein the decision for the target BESS comprises risk-benefit analysis for the decision.

15. The apparatus of claim 13, wherein the data related to the BESS comprises battery module, battery manufacturing characteristics, BESS product and system integrator characteristics.

16. The apparatus of claim 13, wherein the processor is configured to train the reinforcement learning model by formulating a states model configured to learn benefit and risk for the BESS and return a state to a learning environment of the reinforcement learning model, wherein the reinforcement learning model undergoes policy updates from the learning environment.

17. The apparatus of claim 13, wherein the decision indicates whether the target BESS project is to proceed or to be deferred.

18. The apparatus of claim 13, wherein the training the reinforcement learning model comprises assigning decision sequences based on the prior benefit realization probabilities and the risk exposure probabilities.
